(19) United States
(12) Patent Application Publication
(10) Pub. No.: US 2026/0237132 A1
(43) Pub. Date: Aug. 13, 2026

(54) VIDEO GENERATION FROM TEXT

(71) Applicant: NVIDIA Corp., Santa Clara, CA (US)

(72) Inventors: Yufeng Zheng, Zurich (CH); Shalini De Mello, San Francisco, CA (US); Xueting Li, San Jose, CA (US); Karsten Julian Kreis, Vancouver (CA); Koki Nagano, Los Angeles, CA (US); Sifei Liu, San Diego, CA (US)

(73) Assignee: NVIDIA Corp., Santa Clara, CA (US)

(21) Appl. No.: 19/049,363

(22) Filed: Feb. 10, 2025

(51) Int. Cl. G06T 13/20; G06T 15/08; G06T 19/20

(52) U.S. Cl. CPC G06T 13/20; G06T 15/08; G06T 19/20; G06T 2219/2016; G06T 2219/2021

(57) ABSTRACT

Mechanisms for implementing text-to-volumetric video transformers utilizing a first stage configured to transform a text prompt into a three-dimensional neural radiance field, and a second stage configured to apply a four-dimensional multi-resolution deformation field to generate time-varying displacements for the three-dimensional neural radiance field consistent with motion expressed in the text prompt, while maintaining a content of the three-dimensional neural radiance field static.

### BACKGROUND

Diffusion-based generative artificial intelligence (AI) models utilize principles of diffusion and denoising to generate outputs such as images. For example, a model may be configured (trained) by applying a forward diffusion process that gradually adds Gaussian noise to a set of training content, transforming the original training content into versions with varying levels of noise. This process resembles diffusion whereby information dissolves into noise over time.

The model is then trained to reverse this diffusion process. The model is trained to progressively denoise the data, starting from the noisy version and gradually reconstructing the original data distribution.

During training, the model learns a sequence of denoising steps. Each step aims to predict and subtract the added noise from the previous step, effectively reversing the forward diffusion process. The model minimizes a loss function that measures the discrepancy between the predicted and actual noise.

Once trained, the model may begin from a pure noise signal and apply the learned denoising steps iteratively to generate an output that matches a prompt. This reverse diffusion sequence results in the generation of new content that resembles the training data distribution.

Text-conditioned diffusion-based generative AI models are becoming more commonly utilized for content generation from user provided text prompts and images. However, it remains challenging to implement diffusion-based text-to-volumetric video content generation with high quality.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a text-to-volumetric video generative model in one embodiment.

FIG. 2 depicts an exemplary motion field structure.

FIG. 3 depicts a parallel processing unit 302 in accordance with one embodiment.

FIG. 4 depicts a general processing cluster 400 in accordance with one embodiment.

FIG. 5 depicts a memory partition unit 500 in accordance with one embodiment.

FIG. 6 depicts a streaming multiprocessor 600 in accordance with one embodiment.

FIG. 7 depicts a processing system 700 in accordance with one embodiment.

FIG. 8 depicts an exemplary processing system 800 in accordance with another embodiment.

FIG. 9 illustrates an exemplary data center 900, in accordance with at least one embodiment.

### DETAILED DESCRIPTION

For some real-world applications such as gaming, augmented reality, virtual reality, and advertising, it is desirable to generate volumetric video from user-provided text prompts. One example is text-conditioned volumetric video (herein, “video” includes animation) generation, a.k.a., text-to-volumetric video synthesis. Artificial intelligence models trained for these purposes may learn to generate a three-dimensional (3D) representation of a scene described in a text prompt, and may also learn a plausible and semantically-aligned (consistent with the subject, verbs etc. of the text prompt) dynamic evolution of the 3D representation.

In one application, a user may provide a text prompt and optionally one or more images as inputs, and the disclosed transformer mechanisms generate volumetric video motion that matches both an object depicted in the image(s) and the motion expressed in the text prompt.

Disclosed herein are two-stage generative model structures to implement text-to-volumetric video synthesis, utilizing:
1. 3D and two-dimensional (2D) diffusion guidance to effectively learn the generation of high-quality static 3D representations of text prompts in the first stage;
2. A deformable neural radiance field that disentangles generated 3D representations from their deformation, preserving quality during motion learning; and
3. A multi-resolution feature grid for the deformation field to enable motion learning with video diffusion guidance in the second stage.

The disclosed mechanisms apply 3D and 2D diffusion guidance to learn the generation of high-quality 3D representations that provide a canonical model of an object or scene for motion generation. Volumetric videos with realistic appearance and motion matching descriptions and actions in the text prompt may thereby be generated.

A motion generative model may be trained to apply 4D multi-resolution deformation fields with video diffusion guidance to the 3D representations generated in the first stage. Unlike prior approaches, the motion generative model may operate on a static version of a provided 3D representation (the 3D representation is not evolved in the motion generation stage). Multi-resolution feature grids and a novel total variation loss algorithm may be utilized for training the deformation fields of the motion generative model, resulting in more realistic motion.

Total variation loss measures the total amount of variation or differences in intensities across a provided input. Total variation loss helps maintain the structural integrity of the provided input (e.g., preserving edges) while also providing a smoothing effect overall. Mathematically, an example of total variation loss may be expressed as:

$$TV ( I ) = \sqrt{{( {I}_{i + 1 , j , k} - {I}_{i , j , k} )}^{2} + {( {I}_{i , j + 1 , k} - {I}_{i , j , k} )}^{2}}$$

where I represents the input object, and (i, j, k) are sample coordinates within the input object.

Relying solely on guidance from image or video diffusion models for volumetric video synthesis may lead to Janus-type ambiguities (i.e., the generation of inconsistent views). The disclosed mechanisms utilize a combination of 2D, 3D, and video-trained diffusion models to disengage the 3D geometry expressed in the text prompt from motion expressed in the text prompt.

The disengagement of motion learning from the generation of 3D representations cannot be achieved in prior approaches that utilize for example hexplanes. Instead of hexplanes, the disclosed mechanisms employ a novel variant of a deformable neural radiance field (D-NeRF) during motion learning and generation.

A neural radiance field (NeRF) may be embodiment by a deep learning model that synthesizes realistic 3D scenes from diffusion guidance based on a sparse set of images (views). Neural radiance fields (NeRFs) may embed 2D images in a neural network that inputs camera coordinates and generates a volume rendering. Utilizing for example a multi-layer perceptron (MLP) network, NeRFs encode the volumetric scene representation and predict the color and density of points within the space. By leveraging techniques such as volume rendering and differentiable rendering, NeRFs generate continuous volumetric representations that enable novel viewpoints and lighting effects not depicted in the 2D image set.

A deformable neural radiance field (D-NeRF) is a model that extends a neural radiance field to model dynamic and non-rigid structures. Unlike traditional NeRFs that model static 3D objects or scenes, deformable NeRFs incorporate a learning of evolutions in shape and appearance of objects over time. This is achieved through the integration of deformation fields within the neural network framework, which enables the realistic rendering of objects that can bend, twist, or otherwise move in complex ways.

In one embodiment, a four-dimensional (4D) D-NeRF may be implemented by applying a deformation-trained multi-layer perceptron that maps time-dependent deformed space to the canonical static space in a NeRF volume. During training of the D-NeRF with video diffusion guidance, the deformation field may be modified while the provided NeRF remains static.

To successfully learn detailed and realistic motion, the deformation field in the second stage may be encoded with multi-resolution feature grids and the motion may be processed using a total variation loss on the rendered displacement maps. The former may enhance detailed motion while the latter may reduce noisy jitters. The disclosed mechanisms may exhibit improved visual quality, 3D consistency, prompt matching, and motion quality over conventional approaches.

The disclosed text-to-volumetric video transformers may include a first stage configured to transform a text prompt into a three-dimensional neural radiance field, and a second stage configured to apply a four-dimensional multi-resolution deformation field to generate displacements for pixel locations in the three-dimensional neural radiance field consistent with motion expressed in the text prompt, without changing the pixel locations in the three-dimensional neural radiance field. The four-dimensional multi-resolution deformation field may implement a four-dimensional to three-dimensional time-dependent mapping D (x_{d}, t)→x_{c}, where x_{d} is a 3D point's location in deformed space at time t, and x_{c} is the point's corresponding location in the canonical three-dimensional neural radiance field.

The three-dimensional neural radiance field includes a feature grid resolution at least five times greater, and in some embodiments an order of magnitude greater, than a feature grid resolution of the four-dimensional multi-resolution deformation field.

Other technical features may be readily apparent to one skilled in the art from the following figures, descriptions, and claims.

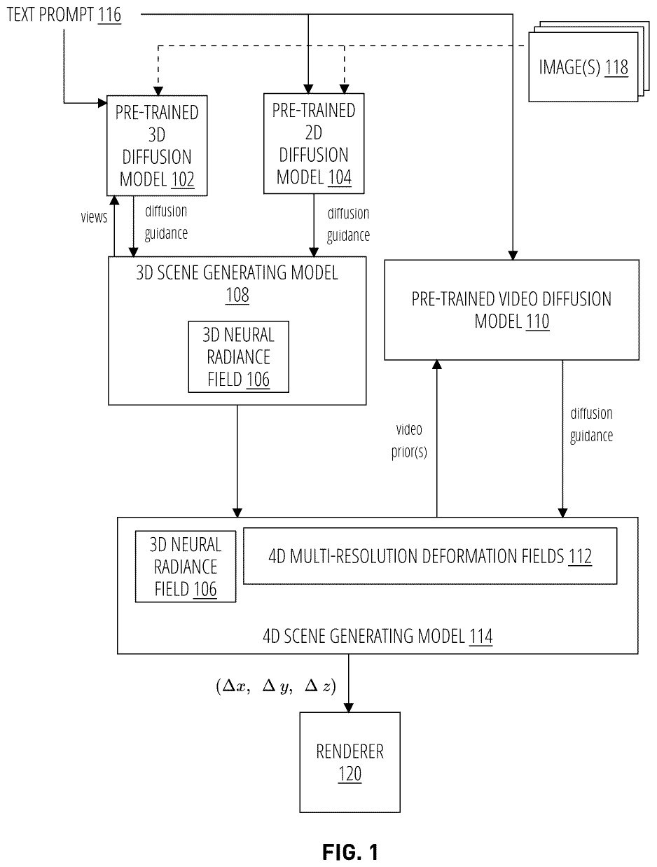

FIG. 1 depicts a text-to-volumetric video transformer network comprising two stages. The transformer network comprises a pre-trained 3D diffusion model 102 and a pre-trained 2D diffusion model 104 that generate views to train the 3D neural radiance fields 106 of a 3D scene generating model 108. The 3D neural radiance fields 106 and diffusion guidance from a pre-trained video diffusion model 110 are applied to train 4D multi-resolution deformation fields 112 embodied by a 4D scene generating model 114 (e.g., a mutli-layer convolutional perceptron network). Layers and hyperparameters of the 4D scene generating model 114 may be implemented in manners known in the art.

The first stage generates a textured 3D representation of an object described in an applied text prompt 116 (e.g., the subject of an action described in the text prompt 116) and optionally one or more applied image 118 inputs. The second stage generates motion (coordinate changes) for the 3D representation in accordance with action expressed in the text prompt 116. The motion is utilized by a renderer 120 to produce volumetric video consistent with the text prompt 116.

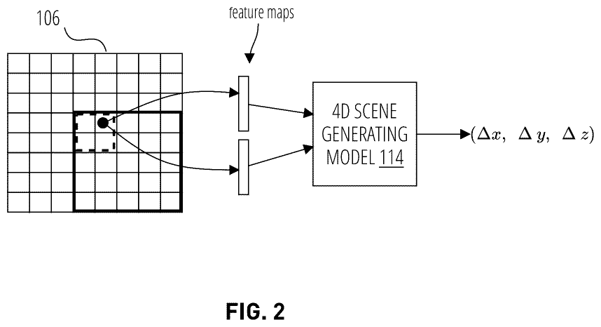

The first stage generates a 3D representation of a scene or object described by the text prompt 116. The 3D representation is embodied in a 3D neural radiance field 106 volume. The second stage applies 4D multi-resolution deformation fields 112 along with guidance from a pre-trained video diffusion model 110 to model the motion described in the text prompt 116. The learned 3D representation is not evolved in the second stage during motion generation. The 3D representation and a deformation field for the 3D representation may both be encoded in multi-resolution feature grids. FIG. 2 depicts an example of a 3D neural radiance field 106 in multiple feature resolutions processed through the motion rendering model's 4D scene generating model 114 to generate movement (coordinate changes) in three dimensions.

One embodiment of a 3D scene generating model 108 inputs camera parameters along with the text prompt 116 and/or the image 118 and generates one or more 2D views of an object(s) specified in the text prompt. The views may be rendered in multiple perspectives, for example from four different viewpoints (i.e., front, back, and left and right side views). In one embodiment, the 3D scene generating model 108 may be configured using score distillation sampling (SDS) from a teacher model.

SDS loss is a technique utilized during the transfer of learning from a complex generative model to a simpler one by matching their score functions. SDS loss involves distilling the score function of a more complex model (the teacher) into a simpler one (the student). The score function may for example represent the gradient of the log probability density with respect to predictions of the model. In diffusion models, the score function may capture how the likelihood of the predictions change as the predictions themselves change. During the transfer learning process, the student model learns to approximate the score function of the teacher model. The SDS loss measures a difference between the score function estimated by the student model and the score function provided by the teacher model. The objective is to minimize this loss, improving the student model's ability to replicate the teacher model's behavior.

The guidance loss may be denoted as L_{3D}(I). A 3D scene generating model 108 generated using only 3D diffusion may tend to produce 3D representations with un-realistic textures, and may occasionally fail to produce realistic scene layouts. The disclosed mechanisms supplement the diffusion guidance from the pre-trained 3D diffusion model 102 with diffusion guidance from a pre-trained 2D diffusion model 104 trained with high-quality 2D images, which may result in a more realistic appearance and semantically-aligned layouts in the generated 3D representation used in motion generation stage. In one embodiment, the pre-trained 2D diffusion model 104 comprises an SDS objective function L_{2D}(I)) providing 2D diffusion guidance.

The overall objectives of the first stage generative operation to produce the 3D representation of an object or scene may be expressed as:

$$L = {λ}_{2 D} {L}_{2 D} ( I ) + {λ}_{3 D} {L}_{3 D} ( I )$$

where I denotes a set of rendered images from the sampled camera viewpoints, and λ_{2D} and λ_{3D} are the weights for the 2D diffusion guidance and the 3D diffusion guidance, respectively. These weights may be determined empirically for different implementations.

The second stage learns the 4D multi-resolution deformation field 112 that animate the 3D representations generated in the first stage, using guidance from the pre-trained video diffusion model 110. The content of the 3D representation generated in the first stage is maintained in an unchanged (static) state during motion learning by the second stage. In other words, the content of the 3D neural radiance field 106 from the first stage is not altered to generate motion in the second stage. In the second stage learning is confined to 4D multi-resolution deformation fields 112 that match the motion described in the text prompt 116. This disentanglement of motion learning from generation of the 3D representation helps preserve the view consistency and high-quality textures from the first stage in the final generated video.

The 4D multi-resolution deformation field 112 may may be configured with (may learn) a time-dependent mapping D (x_{d}, t)→x_{c}, where x_{d} is a 3D point's location in deformed space at time t, and x_{c} is its corresponding spatial location of the point in the 3D neural radiance field 106. The deformation field may be smooth both spatially and temporally. As a result, the deformation field may utilize a much lower resolution feature grid than does the 3D neural radiance field 106 (i.e., the canonical 3D NeRF representation). In one embodiment, the deformation field may be an order of magnitude lower in resolution than the 3D neural radiance field 106.

In one embodiment, 4D multi-resolution deformation field 112 may comprise a four-dimensional, multi-resolution, hash-encoded feature grid with the resolution of the deformation field being lower than the resolution of the 3D neural radiance field 106. Utilizing multiple resolutions of the feature grid may substantially enhance the learning of local motions (changes in shapes, sizes, positions and/or orientations of features within the 3D representation of an object).

Score distillation is a process in machine learning whereby learned configuration settings are transferred from a more complex, typically pre-trained, teacher model to a simpler student model. This distillation process focuses on the scores or probabilities assigned to different classes by the teacher model. Distillation involves training the student model to replicate the output scores (or distributions) of the teacher model, rather than just the hard class labels. The “soft” outputs (probability distributions) of the teacher model often include learning nuances about the relationships between different classes. The loss function utilized for score distillation may for example comprise a version of cross-entropy loss, which measures the divergence between the teacher's and the student's probability distributions.

The deformation field may be trained via score distillation of the pre-trained video diffusion model 110. A variant of SDS loss may be applied for video diffusion guidance, for example predicting the original video with 1-step denoising, utilizing a combination of latent feature loss and decoded red-green-blue (RGB) color space loss.

The video diffusion guidance loss may be expressed as

$${L}_{video} ( V ) = {L}_{latent} ( V ) + {λ}_{dec} {L}_{dec} ( V )$$

where ‘dec’ denotes the decoder of the pre-trained video diffusion model 110 and where λ_{dec} is set for example to 0.1. As shown in the equation above, the SDS loss may be applied for both the latent of a video and for the ‘raw’ (e.g., RGB) video. The first term of the equation represents applying SDS loss on the latent of the predicted video, the second terms represents applying SDS on the raw predicted video.

Examples of pre-trained video diffusion models 110 that may be utilized for the motion priors used to train the second stage deformation field are Zeroscope, Modelscope, OpenAI's® SORA, and Nvidia® Corporation's Cosmos. Matching the resolution of the deformation fields to the resolution used to train the pre-trained video diffusion models 110 may increase the likelihood of successfully distilling motion priors.

To reduce temporal and spatial jittering in the motion, an unconventional total variation loss algorithm may be utilized to train the 4D multi-resolution deformation field 112. Specifically, in addition to the video V, a second video may be rendered for the 3D displacements D. The total variation loss on the rendered displacement video D may be expressed as:

$${L}_{TV} ( D ) = {\sum }_{x , y , t} ( {\vert {D}_{x - 1 , y , t} - {D}_{x , y , t} \vert}_{2}^{2} + {\vert {D}_{x , y - 1 , t} - {D}_{x , y , t} \vert}_{2}^{2} + {\vert {D}_{x , y , t - 1} - {D}_{x , y , t} \vert}_{2}^{2} )$$

The overall objective function for the second stage may in one embodiment be expressed as:

$$L = {L}_{video} ( V ) + {λ}_{TV} {L}_{TV} ( D )$$

where λ_{TV}v is equal for example to 1000.

One application of the transformer network of FIG. 1 involves the generation of video that feature a specific 3D object. In these applications, the text prompt 116 alone may be insufficient to express the unique appearance of the object. The disclosed mechanisms are readily extended to image-only (no text prompt 116) guided video generation without modification to the motion learning (second) stage. This may for example be readily implemented utilizing different diffusion models in the first stage.

For example, for video generation informed by a single image, a 3D representation for use in the motion learning stage may be generated using an image-conditioned 3D diffusion model (e.g., zero123-x1). A 2D diffusion model such as DeepfloydIF may also be used. Additionally, a reference view may be included with the provided image and its estimated foreground mask.

Available tools such as Dreambooth may input a few casually (not formally composed) captured images of an object, and utilize these inputs to finetune an image diffusion model to generate personalized (to a particular person, application, set of requirement, etc.) images of the object given the text prompt 116. Replacing a generic image diffusion model in the first stage with a fine-tuned, personalized version may enable the generation of personalized 3D representations for use in the second stage, based on a provided text prompt and a few casual images. For example a personalized version of StableDiffusion (a well-known family of 2D diffusion models) together with MVDream (a well-known family of 3D diffusion models) may be utilized for this purpose in one embodiment.

The deep learning models and mechanisms disclosed herein may be implemented as logic, e.g., machine-readable instructions stored in a non-transitory machine memory device or devices, that configures computing devices utilizing one or more graphic processing unit (GPU) and/or general purpose data processor (e.g., a 'central processing unit or CPU). Exemplary architectures will now be described that may be configured to implement the models and mechanisms disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

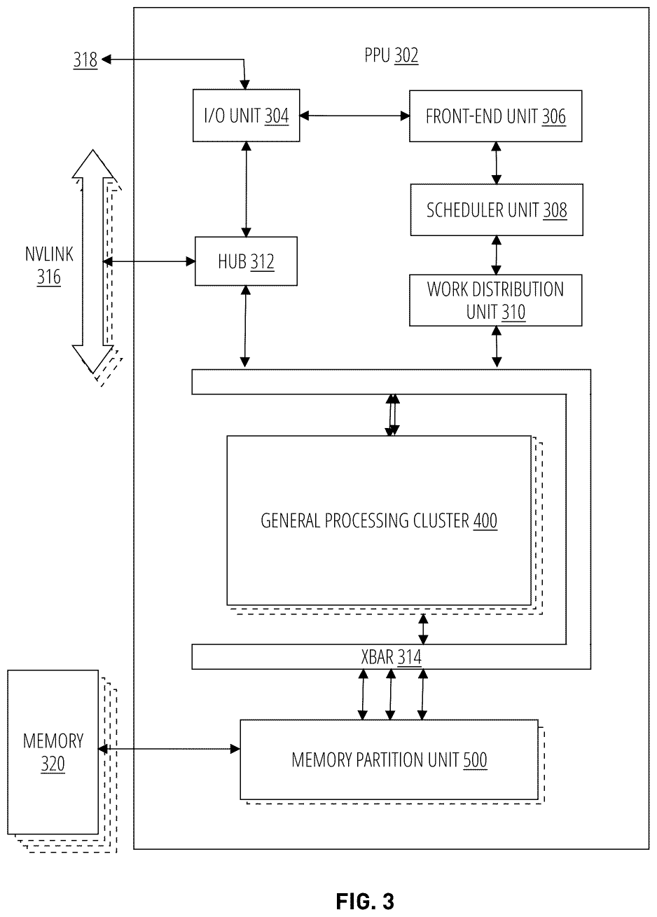

FIG. 3 depicts a parallel processing unit 302, in accordance with an embodiment. In an embodiment, the parallel processing unit 302 is a multi-threaded processor that is implemented on one or more integrated circuit devices. The parallel processing unit 302 is a latency hiding architecture designed to process many threads in parallel. A thread (e.g., a thread of execution) is an instantiation of a set of instructions configured to be executed by the parallel processing unit 302. In an embodiment, the parallel processing unit 302 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 302 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 302 modules may be configured to accelerate thousands of High Performance Computing (HPC), data center, and machine learning applications. The parallel processing unit 302 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the parallel processing unit 302 includes an I/O unit 304, a front-end unit 306, a scheduler unit 308, a work distribution unit 310, a hub 312, a crossbar 314, one or more general processing cluster 400 modules, and one or more memory partition unit 500 modules. The parallel processing unit 302 may be connected to a host processor or other parallel processing unit 302 modules via one or more high-speed NVLink 316 interconnects. The parallel processing unit 302 may be connected to a host processor or other peripheral devices via an interconnect 318. The parallel processing unit 302 may also be connected to a local memory comprising a number of memory 320 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 320 may comprise logic to configure the parallel processing unit 302 to carry out aspects of the techniques disclosed herein.

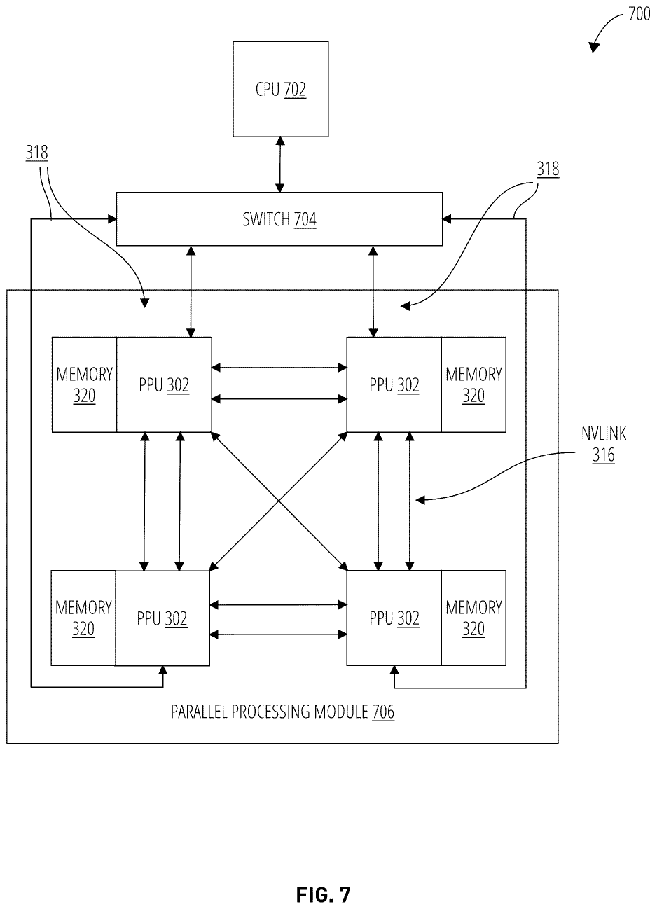

The NVLink 316 interconnect enables systems to scale and include one or more parallel processing unit 302 modules combined with one or more CPUs, supports cache coherence between the parallel processing unit 302 modules and CPUs, and CPU mastering. Data and/or commands may be transmitted by the NVLink 316 through the hub 312 to/from other units of the parallel processing unit 302 such as one or more copy engines, a video encoder, a video decoder, a power management unit, etc. (not explicitly shown). The NVLink 316 is described in more detail in conjunction with FIG. 7.

The I/O unit 304 is configured to transmit and receive communications (e.g., commands, data, etc.) from a host processor (not shown) over the interconnect 318. The I/O unit 304 may communicate with the host processor directly via the interconnect 318 or through one or more intermediate devices such as a memory bridge. In an embodiment, the I/O unit 304 may communicate with one or more other processors, such as one or more parallel processing unit 302 modules via the interconnect 318. In an embodiment, the I/O unit 304 implements a Peripheral Component Interconnect Express (PCIe) interface for communications over a PCIe bus and the interconnect 318 is a PCIe bus. In alternative embodiments, the I/O unit 304 may implement other types of well-known interfaces for communicating with external devices.

The I/O unit 304 decodes packets received via the interconnect 318. In an embodiment, the packets represent commands configured to cause the parallel processing unit 302 to perform various operations. The I/O unit 304 transmits the decoded commands to various other units of the parallel processing unit 302 as the commands may specify. For example, some commands may be transmitted to the front-end unit 306. Other commands may be transmitted to the hub 312 or other units of the parallel processing unit 302 such as one or more copy engines, a video encoder, a video decoder, a power management unit, etc. (not explicitly shown). In other words, the I/O unit 304 is configured to route communications between and among the various logical units of the parallel processing unit 302.

In an embodiment, a program executed by the host processor encodes a command stream in a buffer that provides workloads to the parallel processing unit 302 for processing. A workload may comprise several instructions and data to be processed by those instructions. The buffer is a region in a memory that is accessible (e.g., read/write) by both the host processor and the parallel processing unit 302. For example, the I/O unit 304 may be configured to access the buffer in a system memory connected to the interconnect 318 via memory requests transmitted over the interconnect 318. In an embodiment, the host processor writes the command stream to the buffer and then transmits a pointer to the start of the command stream to the parallel processing unit 302. The front-end unit 306 receives pointers to one or more command streams. The front-end unit 306 manages the one or more streams, reading commands from the streams and forwarding commands to the various units of the parallel processing unit 302.

The front-end unit 306 is coupled to a scheduler unit 308 that configures the various general processing cluster 400 modules to process tasks defined by the one or more streams. The scheduler unit 308 is configured to track state information related to the various tasks managed by the scheduler unit 308. The state may indicate which general processing cluster 400 a task is assigned to, whether the task is active or inactive, a priority level associated with the task, and so forth. The scheduler unit 308 manages the execution of a plurality of tasks on the one or more general processing cluster 400 modules.

The scheduler unit 308 is coupled to a work distribution unit 310 that is configured to dispatch tasks for execution on the general processing cluster 400 modules. The work distribution unit 310 may track a number of scheduled tasks received from the scheduler unit 308. In an embodiment, the work distribution unit 310 manages a pending task pool and an active task pool for each of the general processing cluster 400 modules. The pending task pool may comprise a number of slots (e.g., 32 slots) that contain tasks assigned to be processed by a particular general processing cluster 400. The active task pool may comprise a number of slots (e.g., 4 slots) for tasks that are actively being processed by the general processing cluster 400 modules. As a general processing cluster 400 finishes the execution of a task, that task is evicted from the active task pool for the general processing cluster 400 and one of the other tasks from the pending task pool is selected and scheduled for execution on the general processing cluster 400. If an active task has been idle on the general processing cluster 400, such as while waiting for a data dependency to be resolved, then the active task may be evicted from the general processing cluster 400 and returned to the pending task pool while another task in the pending task pool is selected and scheduled for execution on the general processing cluster 400.

The work distribution unit 310 communicates with the one or more general processing cluster 400 modules via crossbar 314. The crossbar 314 is an interconnect network that couples many of the units of the parallel processing unit 302 to other units of the parallel processing unit 302. For example, the crossbar 314 may be configured to couple the work distribution unit 310 to a particular general processing cluster 400. Although not shown explicitly, one or more other units of the parallel processing unit 302 may also be connected to the crossbar 314 via the hub 312.

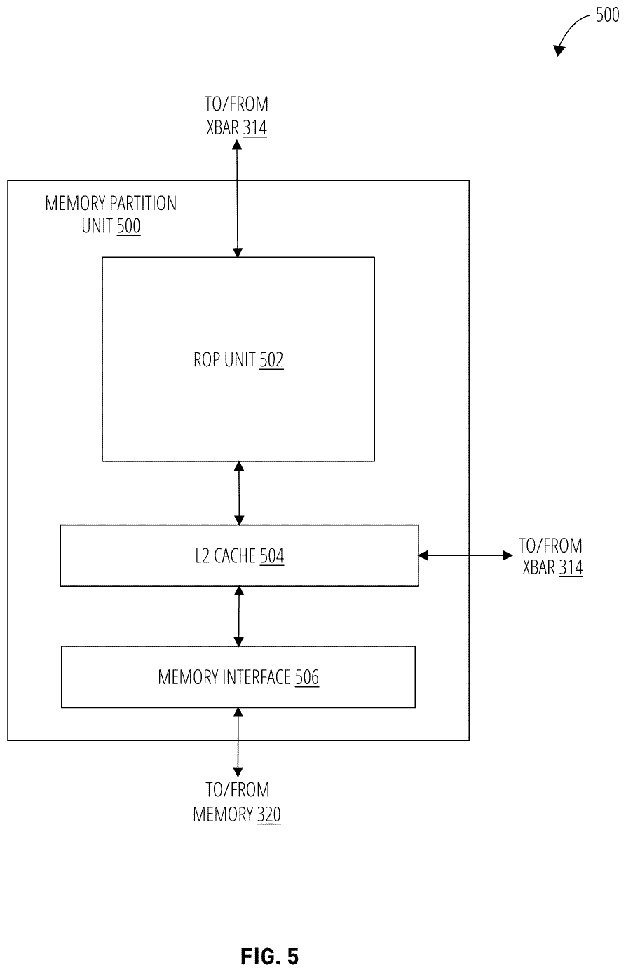

The tasks are managed by the scheduler unit 308 and dispatched to a general processing cluster 400 by the work distribution unit 310. The general processing cluster 400 is configured to process the task and generate results. The results may be consumed by other tasks within the general processing cluster 400, routed to a different general processing cluster 400 via the crossbar 314, or stored in the memory 320. The results can be written to the memory 320 via the memory partition unit 500 modules, which implement a memory interface for reading and writing data to/from the memory 320. The results can be transmitted to another parallel processing unit 302 or CPU via the NVLink 316. In an embodiment, the parallel processing unit 302 includes a number U of memory partition unit 500 modules that is equal to the number of separate and distinct memory 320 devices coupled to the parallel processing unit 302. A memory partition unit 500 will be described in more detail below in conjunction with FIG. 5.

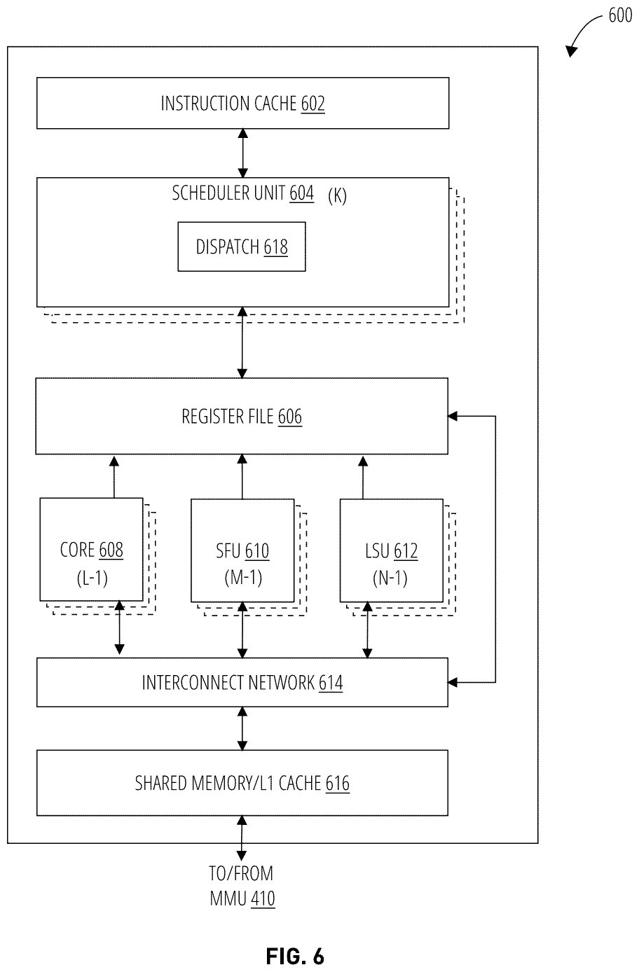

In an embodiment, a host processor executes a driver kernel that implements an application programming interface (API) that enables one or more applications executing on the host processor to schedule operations for execution on the parallel processing unit 302. In an embodiment, multiple compute applications are simultaneously executed by the parallel processing unit 302 and the parallel processing unit 302 provides isolation, quality of service (QoS), and independent address spaces for the multiple compute applications. An application may generate instructions (e.g., API calls) that cause the driver kernel to generate one or more tasks for execution by the parallel processing unit 302. The driver kernel outputs tasks to one or more streams being processed by the parallel processing unit 302. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 6.

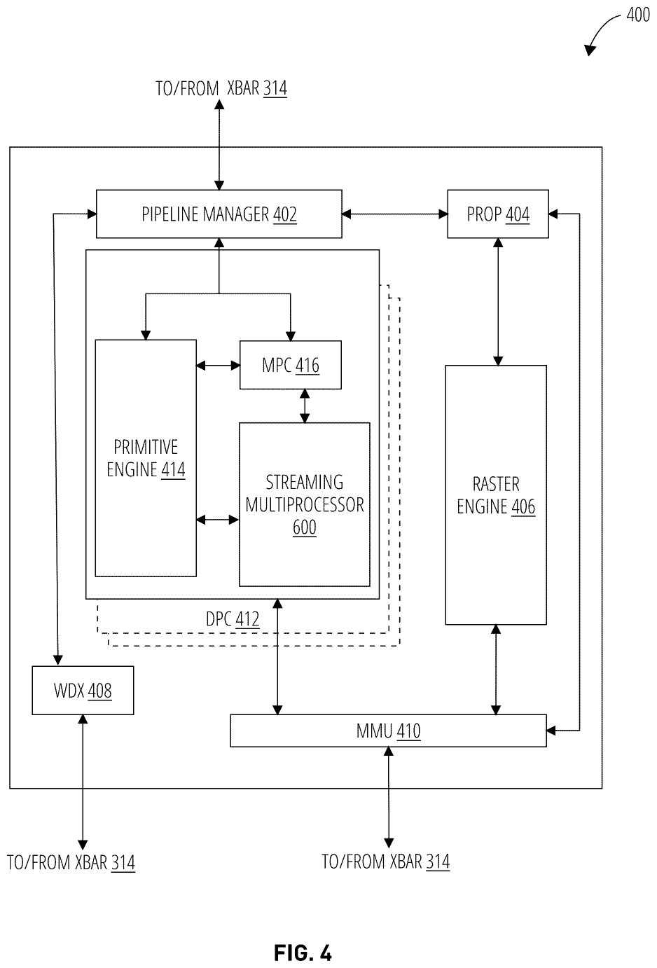

FIG. 4 depicts a general processing cluster 400 of the parallel processing unit 302 of FIG. 3, in accordance with an embodiment. As shown in FIG. 4, each general processing cluster 400 includes a number of hardware units for processing tasks. In an embodiment, each general processing cluster 400 includes a pipeline manager 402, a pre-raster operations unit 404, a raster engine 406, a work distribution crossbar 408, a memory management unit 410, and one or more data processing cluster 412. It will be appreciated that the general processing cluster 400 of FIG. 4 may include other hardware units in lieu of or in addition to the units shown in FIG. 4.

In an embodiment, the operation of the general processing cluster 400 is controlled by the pipeline manager 402. The pipeline manager 402 manages the configuration of the one or more data processing cluster 412 modules for processing tasks allocated to the general processing cluster 400. In an embodiment, the pipeline manager 402 may configure at least one of the one or more data processing cluster 412 modules to implement at least a portion of a graphics rendering pipeline. For example, a data processing cluster 412 may be configured to execute a vertex shader program on the programmable streaming multiprocessor 600. The pipeline manager 402 may also be configured to route packets received from the work distribution unit 310 to the appropriate logical units within the general processing cluster 400. For example, some packets may be routed to fixed function hardware units in the pre-raster operations unit 404 and/or raster engine 406 while other packets may be routed to the data processing cluster 412 modules for processing by the primitive engine 414 or the streaming multiprocessor 600. In an embodiment, the pipeline manager 402 may configure at least one of the one or more data processing cluster 412 modules to implement a neural network model and/or a computing pipeline.

The pre-raster operations unit 404 is configured to route data generated by the raster engine 406 and the data processing cluster 412 modules to a Raster Operations (ROP) unit, described in more detail in conjunction with FIG. 5. The pre-raster operations unit 404 may also be configured to perform optimizations for color blending, organize pixel data, perform address translations, and the like.

The raster engine 406 includes a number of fixed function hardware units configured to perform various raster operations. In an embodiment, the raster engine 406 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 406 comprises fragments to be processed, for example, by a fragment shader implemented within a data processing cluster 412.

Each data processing cluster 412 included in the general processing cluster 400 includes an M-pipe controller 416, a primitive engine 414, and one or more streaming multiprocessor 600 modules. The M-pipe controller 416 controls the operation of the data processing cluster 412, routing packets received from the pipeline manager 402 to the appropriate units in the data processing cluster 412. For example, packets associated with a vertex may be routed to the primitive engine 414, which is configured to fetch vertex attributes associated with the vertex from the memory 320. In contrast, packets associated with a shader program may be transmitted to the streaming multiprocessor 600.

The streaming multiprocessor 600 comprises a programmable streaming processor that is configured to process tasks represented by a number of threads. Each streaming multiprocessor 600 is multi-threaded and configured to execute a plurality of threads (e.g., 32 threads) from a particular group of threads concurrently. In an embodiment, the streaming multiprocessor 600 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 600 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 600 will be described in more detail below in conjunction with FIG. 6.

The memory management unit 410 provides an interface between the general processing cluster 400 and the memory partition unit 500. The memory management unit 410 may provide translation of virtual addresses into physical addresses, memory protection, and arbitration of memory requests. In an embodiment, the memory management unit 410 provides one or more translation lookaside buffers (TLBs) for performing translation of virtual addresses into physical addresses in the memory 320.

FIG. 5 depicts a memory partition unit 500 of the parallel processing unit 302 of FIG. 3, in accordance with an embodiment. As shown in FIG. 5, the memory partition unit 500 includes a raster operations unit 502, a level two cache 504, and a memory interface 506. The memory interface 506 is coupled to the memory 320. Memory interface 506 may implement 32, 64, 128, 1024-bit data buses, or the like, for high-speed data transfer. In an embodiment, the parallel processing unit 302 incorporates U memory interface 506 modules, one memory interface 506 per pair of memory partition unit 500 modules, where each pair of memory partition unit 500 modules is connected to a corresponding memory 320 device. For example, parallel processing unit 302 may be connected to up to Y memory 320 devices, such as high bandwidth memory stacks or graphics double-data-rate, version 5, synchronous dynamic random access memory, or other types of persistent storage.

In an embodiment, the memory interface 506 implements an HBM2 memory interface and Y equals half U. In an embodiment, the HBM2 memory stacks are located on the same physical package as the parallel processing unit 302, providing substantial power and area savings compared with conventionalGDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 320 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 302 modules process very large datasets and/or run applications for extended periods.

In an embodiment, the parallel processing unit 302 implements a multi-level memory hierarchy. In an embodiment, the memory partition unit 500 supports a unified memory to provide a single unified virtual address space for CPU and parallel processing unit 302 memory, enabling data sharing between virtual memory systems. In an embodiment the frequency of accesses by a parallel processing unit 302 to memory located on other processors is traced to ensure that memory pages are moved to the physical memory of the parallel processing unit 302 that is accessing the pages more frequently. In an embodiment, the NVLink 316 supports address translation services allowing the parallel processing unit 302 to directly access a CPU's page tables and providing full access to CPU memory by the parallel processing unit 302.

In an embodiment, copy engines transfer data between multiple parallel processing unit 302 modules or between parallel processing unit 302 modules and CPUs. The copy engines can generate page faults for addresses that are not mapped into the page tables. The memory partition unit 500 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 320 or other system memory may be fetched by the memory partition unit 500 and stored in the level two cache 504, which is located on-chip and is shared between the various general processing cluster 400 modules. As shown, each memory partition unit 500 includes a portion of the level two cache 504 associated with a corresponding memory 320 device. Lower level caches may then be implemented in various units within the general processing cluster 400 modules. For example, each of the streaming multiprocessor 600 modules may implement an L1 cache. The L1 cache is private memory that is dedicated to a particular streaming multiprocessor 600. Data from the level two cache 504 may be fetched and stored in each of the L1 caches for processing in the functional units of the streaming multiprocessor 600 modules. The level two cache 504 is coupled to the memory interface 506 and the crossbar 314.

The raster operations unit 502 performs graphics raster operations related to pixel color, such as color compression, pixel blending, and the like. The raster operations unit 502 also implements depth testing in conjunction with the raster engine 406, receiving a depth for a sample location associated with a pixel fragment from the culling engine of the raster engine 406. The depth is tested against a corresponding depth in a depth buffer for a sample location associated with the fragment. If the fragment passes the depth test for the sample location, then the raster operations unit 502 updates the depth buffer and transmits a result of the depth test to the raster engine 406. It will be appreciated that the number of partition memory partition unit 500 modules may be different than the number of general processing cluster 400 modules and, therefore, each raster operations unit 502 may be coupled to each of the general processing cluster 400 modules. The raster operations unit 502 tracks packets received from the different general processing cluster 400 modules and determines which general processing cluster 400 that a result generated by the raster operations unit 502 is routed to through the crossbar 314. Although the raster operations unit 502 is included within the memory partition unit 500 in FIG. 5, in other embodiment, the raster operations unit 502 may be outside of the memory partition unit 500. For example, the raster operations unit 502 may reside in the general processing cluster 400 or another unit.

FIG. 6 illustrates the streaming multiprocessor 600 of FIG. 4, in accordance with an embodiment. As shown in FIG. 6, the streaming multiprocessor 600 includes an instruction cache 602, one or more scheduler unit 604 modules (e.g., such as scheduler unit 308), a register file 606, one or more processing core 608 modules, one or more special function unit 610 modules, one or more load/store unit 612 modules, an interconnect network 614, and a shared memory/L1 cache 616.

As described above, the work distribution unit 310 dispatches tasks for execution on the general processing cluster 400 modules of the parallel processing unit 302. The tasks are allocated to a particular data processing cluster 412 within a general processing cluster 400 and, if the task is associated with a shader program, the task may be allocated to a streaming multiprocessor 600. The scheduler unit 308 receives the tasks from the work distribution unit 310 and manages instruction scheduling for one or more thread blocks assigned to the streaming multiprocessor 600. The scheduler unit 604 schedules thread blocks for execution as warps of parallel threads, where each thread block is allocated at least one warp. In an embodiment, each warp executes 32 threads. The scheduler unit 604 may manage a plurality of different thread blocks, allocating the warps to the different thread blocks and then dispatching instructions from the plurality of different cooperative groups to the various functional units (e.g., core 608 modules, special function unit 610 modules, and load/store unit 612 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 618 unit is configured within the scheduler unit 604 to transmit instructions to one or more of the functional units. In one embodiment, the scheduler unit 604 includes two dispatch 618 units that enable two different instructions from the same warp to be dispatched during each clock cycle. In alternative embodiments, each scheduler unit 604 may include a single dispatch 618 unit or additional dispatch 618 units.

Each streaming multiprocessor 600 includes a register file 606 that provides a set of registers for the functional units of the streaming multiprocessor 600. In an embodiment, the register file 606 is divided between each of the functional units such that each functional unit is allocated a dedicated portion of the register file 606. In another embodiment, the register file 606 is divided between the different warps being executed by the streaming multiprocessor 600. The register file 606 provides temporary storage for operands connected to the data paths of the functional units.

Each streaming multiprocessor 600 comprises L processing core 608 modules. In an embodiment, the streaming multiprocessor 600 includes a large number (e.g., 128, etc.) of distinct processing core 608 modules. Each core 608 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 608 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 608 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 600 also comprises M special function unit 610 modules that perform special functions (e.g., attribute evaluation, reciprocal square root, and the like). In an embodiment, the special function unit 610 modules may include a tree traversal unit configured to traverse a hierarchical tree data structure. In an embodiment, the special function unit 610 modules may include texture unit configured to perform texture map filtering operations. In an embodiment, the texture units are configured to load texture maps (e.g., a 2D array of texels) from the memory 320 and sample the texture maps to produce sampled texture values for use in shader programs executed by the streaming multiprocessor 600. In an embodiment, the texture maps are stored in the shared memory/L1 cache 616. The texture units implement texture operations such as filtering operations using mip-maps (e.g., texture maps of varying levels of detail). In an embodiment, each streaming multiprocessor 600 includes two texture units.

Each streaming multiprocessor 600 also comprises N load/store unit 612 modules that implement load and store operations between the shared memory/L1 cache 616 and the register file 606. Each streaming multiprocessor 600 includes an interconnect network 614 that connects each of the functional units to the register file 606 and the load/store unit 612 to the register file 606 and shared memory/L1 cache 616. In an embodiment, the interconnect network 614 is a crossbar that can be configured to connect any of the functional units to any of the registers in the register file 606 and connect the load/store unit 612 modules to the register file 606 and memory locations in shared memory/L1 cache 616.

The shared memory/L1 cache 616 is an array of on-chip memory that allows for data storage and communication between the streaming multiprocessor 600 and the primitive engine 414 and between threads in the streaming multiprocessor 600. In an embodiment, the shared memory/L1 cache 616 comprises 128 KB of storage capacity and is in the path from the streaming multiprocessor 600 to the memory partition unit 500. The shared memory/L1 cache 616 can be used to cache reads and writes. One or more of the shared memory/L1 cache 616, level two cache 504, and memory 320 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 616 enables the shared memory/L1 cache 616 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 310 assigns and distributes blocks of threads directly to the data processing cluster 412 modules. The threads in a block execute the same program, using a unique thread ID in the calculation to ensure each thread generates unique results, using the streaming multiprocessor 600 to execute the program and perform calculations, shared memory/L1 cache 616 to communicate between threads, and the load/store unit 612 to read and write global memory through the shared memory/L1 cache 616 and the memory partition unit 500. When configured for general purpose parallel computation, the streaming multiprocessor 600 can also write commands that the scheduler unit 308 can use to launch new work on the data processing cluster 412 modules.

The parallel processing unit 302 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 302 is embodied on a single semiconductor substrate. In another embodiment, the parallel processing unit 302 is included in a system-on-a-chip (SoC) along with one or more other devices such as additional parallel processing unit 302 modules, the memory 320, a reduced instruction set computer (RISC) CPU, a memory management unit (MMU), a digital-to-analog converter (DAC), and the like.

In an embodiment, the parallel processing unit 302 may be included on a graphics card that includes one or more memory devices. The graphics card may be configured to interface with a PCIe slot on a motherboard of a desktop computer. In yet another embodiment, the parallel processing unit 302 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 7 is a conceptual diagram of a processing system 700 implemented using the parallel processing unit 302 of FIG. 3, in accordance with an embodiment. The processing system 700 includes a central processing unit 702, switch 704, and multiple parallel processing unit 302 modules each and respective memory 320 modules. The NVLink 316 provides high-speed communication links between each of the parallel processing unit 302 modules. Although a particular number of NVLink 316 and interconnect 318 connections are illustrated in FIG. 7, the number of connections to each parallel processing unit 302 and the central processing unit 702 may vary. The switch 704 interfaces between the interconnect 318 and the central processing unit 702. The parallel processing unit 302 modules, memory 320 modules, and NVLink 316 connections may be situated on a single semiconductor platform to form a parallel processing module 706. In an embodiment, the switch 704 supports two or more protocols to interface between various different connections and/or links.

In another embodiment (not shown), the NVLink 316 provides one or more high-speed communication links between each of the parallel processing unit modules (parallel processing unit 302, parallel processing unit 302, parallel processing unit 302, and parallel processing unit 302) and the central processing unit 702 and the switch 704 interfaces between the interconnect 318 and each of the parallel processing unit modules. The parallel processing unit modules, memory 320 modules, and interconnect 318 may be situated on a single semiconductor platform to form a parallel processing module 706. In yet another embodiment (not shown), the interconnect 318 provides one or more communication links between each of the parallel processing unit modules and the central processing unit 702 and the switch 704 interfaces between each of the parallel processing unit modules using the NVLink 316 to provide one or more high-speed communication links between the parallel processing unit modules. In another embodiment (not shown), the NVLink 316 provides one or more high-speed communication links between the parallel processing unit modules and the central processing unit 702 through the switch 704. In yet another embodiment (not shown), the interconnect 318 provides one or more communication links between each of the parallel processing unit modules directly. One or more of the NVLink 316 high-speed communication links may be implemented as a physical NVLink interconnect or either an on-chip or on-die interconnect using the same protocol as the NVLink 316.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 706 may be implemented as a circuit board substrate and each of the parallel processing unit modules and/or memory 320 modules may be packaged devices. In an embodiment, the central processing unit 702, switch 704, and the parallel processing module 706 are situated on a single semiconductor platform.

In an embodiment, the signaling rate of each NVLink 316 is 20 to 25 Gigabits/second and each parallel processing unit module includes six NVLink 316 interfaces (as shown in FIG. 7, five NVLink 316 interfaces are included for each parallel processing unit module). Each NVLink 316 provides a data transfer rate of 25 Gigabytes/second in each direction, with six links providing 300 Gigabytes/second. The NVLink 316 can be used exclusively for PPU-to-PPU communication as shown in FIG. 7, or some combination of PPU-to-PPU and PPU-to-CPU, when the central processing unit 702 also includes one or more NVLink 316 interfaces.

In an embodiment, the NVLink 316 allows direct load/store/atomic access from the central processing unit 702 to each parallel processing unit module's memory 320. In an embodiment, the NVLink 316 supports coherency operations, allowing data read from the memory 320 modules to be stored in the cache hierarchy of the central processing unit 702, reducing cache access latency for the central processing unit 702. In an embodiment, the NVLink 316 includes support for Address Translation Services (ATS), enabling the parallel processing unit module to directly access page tables within the central processing unit 702. One or more of the NVLink 316 may also be configured to operate in a low-power mode.

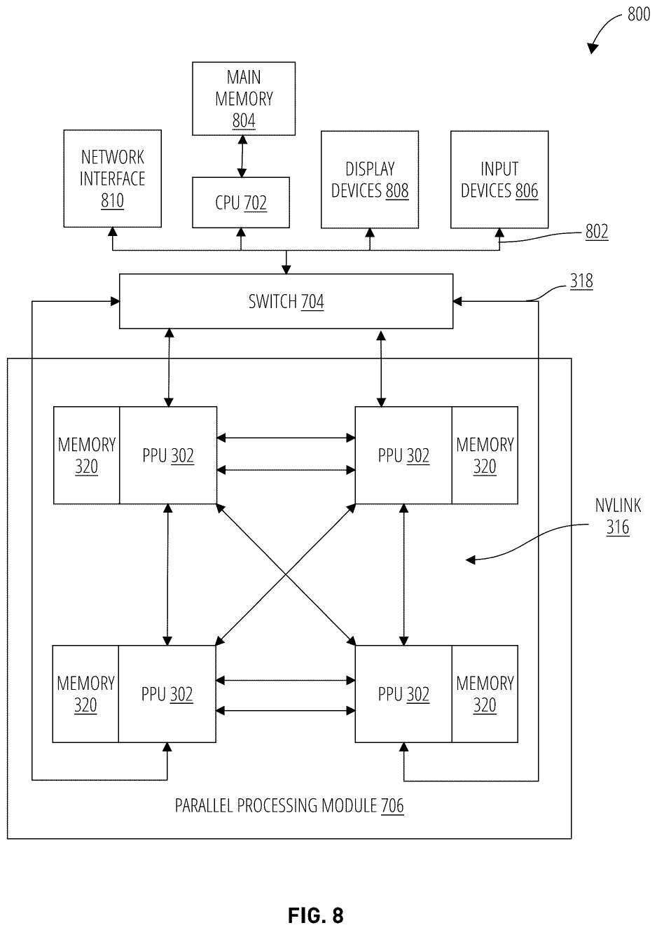

FIG. 8 depicts an exemplary processing system 800 in which the various architecture and/or functionality of the various previous embodiments may be implemented. As shown, an exemplary processing system 800 is provided including at least one central processing unit 702 that is connected to a communications bus 802. The communication communications bus 802 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 800 also includes a main memory 804. Control logic (software) and data are stored in the main memory 804 which may take the form of random access memory (RAM).

The exemplary processing system 800 also includes input devices 806, the parallel processing module 706, and display devices 808, e.g. a conventional CRT (cathode ray tube), LCD (liquid crystal display), LED (light emitting diode), plasma display or the like. User input may be received from the input devices 806, e.g., keyboard, mouse, touchpad, microphone, and the like. Each of the foregoing modules and/or devices may even be situated on a single semiconductor platform to form the exemplary processing system 800. Alternately, the various modules may also be situated separately or in various combinations of semiconductor platforms per the desires of the user.

Further, the exemplary processing system 800 may be coupled to a network (e.g., a telecommunications network, local area network (LAN), wireless network, wide area network (WAN) such as the Internet, peer-to-peer network, cable network, or the like) through a network interface 810 for communication purposes.

The exemplary processing system 800 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage. Such computer programs, when executed, enable the exemplary processing system 800 to perform various functions. The main memory 804, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 800 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

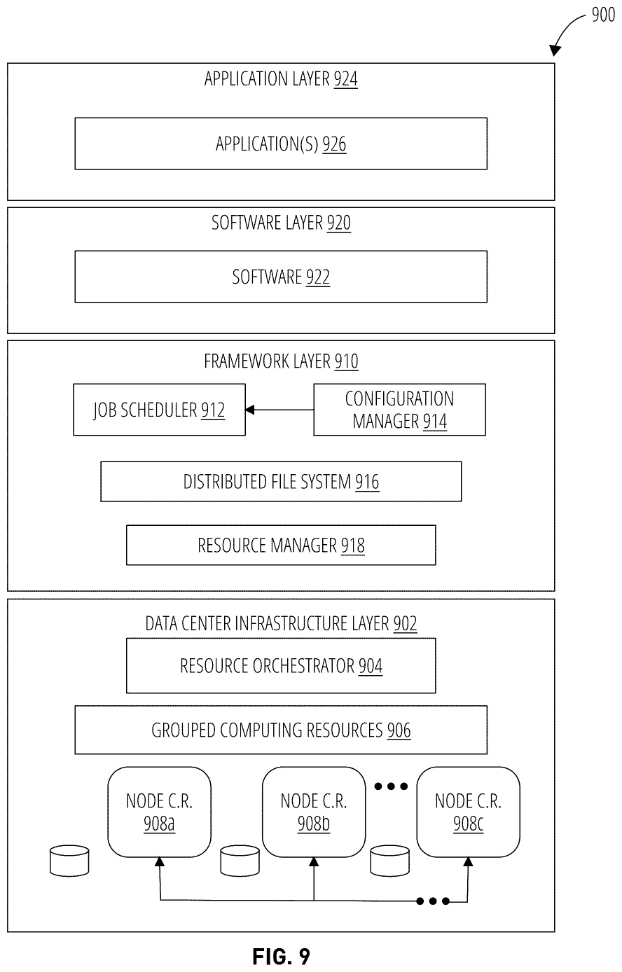

FIG. 9 depicts an exemplary data center 900 that may be configured to implement the disclosed mechanisms, in accordance with at least one embodiment. In at least one embodiment, data center 900 includes, without limitation, a data center infrastructure layer 902, a framework layer 910, a software layer 920, and an application layer 924.

In at least one embodiment, as depicted in FIG. 9, data center infrastructure layer 902 may include a resource orchestrator 904, grouped computing resources 906, and node computing resources (node C.R.s) 908a, 908b, 908c, where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices (e.g., dynamic read-only memory), storage devices (e.g., solid state or disk drives), network input/output (NW I/O) devices, network switches, virtual machines (VMs), power modules, and cooling modules, etc. In at least one embodiment, one or more node computing resources from among node computing resources 908a, 908b, 908c may be a server having one or more of the above-mentioned computing resources.

One or more of the node computing resources 908a, 908b, 908c may be configured to implement the disclosed mechanisms, for example by configuring a memory with machine-readable instructions that when applied to one or more graphics processing unit, configure the one or more node computing resources 908a, 908b, 908c to implement the disclosed mechanisms.

In at least one embodiment, grouped computing resources 906 may include separate groupings of node computing resources housed within one or more racks (not shown), or many racks housed in data centers at various geographical locations (also not shown). Separate groupings of node computing resources within grouped computing resources 906 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 904 may configure or otherwise control one or more node computing resources 908a, 908b, 908c and/or grouped computing resources 906. In at least one embodiment, resource orchestrator 904 may include a software design infrastructure (“SDI”) management entity for data center 900. In at least one embodiment, resource orchestrator 904 may include hardware, software, or some combination thereof.

In at least one embodiment, as depicted in FIG. 9, framework layer 910 includes, without limitation, a job scheduler 912, a configuration manager 914, a resource manager 918, and a distributed file system 916. In at least one embodiment, framework layer 910 may include a framework to support software 922 of software layer 920 and/or one or more application(s) 926 of application layer 220. In at least one embodiment, software 922 or application(s) 926 may respectively include web-based service software or applications, such as those provided by Amazon Web Services, Google Cloud, and Microsoft Azure. In at least one embodiment, framework layer 910 may be, but is not limited to, a type of free and open-source software web application framework such as Apache SPARK™ (hereinafter “Spark) that may utilize a distributed file system 916 for large-scale data processing (e.g., “big data”). In at least one embodiment, job scheduler 912 may include a Spark driver to facilitate scheduling of workloads supported by various layers of data center 900. In at least one embodiment, configuration manager 914 may be capable of configuring different layers such as software layer 920 and framework layer 910, including Spark and distributed file system 916 for supporting large-scale data processing. In at least one embodiment, resource manager 918 may be capable of managing clustered or grouped computing resources mapped to or allocated for support of distributed file system 916 and job scheduler 912. In at least one embodiment, clustered or grouped computing resources may include grouped computing resources 906 at data center infrastructure layer 902. In at least one embodiment, resource manager 918 may coordinate with resource orchestrator 904 to manage these mapped or allocated computing resources.

In at least one embodiment, software 922 included in software layer 920 may include software used by at least portions of node computing resources 908a, 908b, 908c, grouped computing resources 906, and/or distributed file system 916 of framework layer 910. One or more types of software may include, but are not limited to, Internet web page search software, e-mail virus scan software, database software, and streaming video content software.

In at least one embodiment, application(s) 926 included in application layer 924 may include one or more types of applications used by at least portions of node computing resources 908a, 908b, 908c, grouped computing resources 906, and/or distributed file system 916 of framework layer 910. In at least one or more types of applications may include, without limitation, Compute Unified Device Architecture (CUDA) applications, 5G network applications, artificial intelligence applications, data center applications, and/or variations thereof.

In at least one embodiment, any of configuration manager 914, resource manager 918, and resource orchestrator 904 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poorly performing portions of a data center.

### LISTING OF DRAWING ELEMENTS

102 pre-trained 3D diffusion model
104 pre-trained 2D diffusion model
106 3D neural radiance field
108 3D scene generating model
110 pre-trained video diffusion model
112 4D multi-resolution deformation field
114 4D scene generating model
116 text prompt
118 image
120 renderer
302 parallel processing unit
304 I/O unit
306 front-end unit
308 scheduler unit
310 work distribution unit
312 hub
314 crossbar
316 NVLink
318 interconnect
320 memory
400 general processing cluster
402 pipeline manager
404 pre-raster operations unit
406 raster engine
408 work distribution crossbar
410 memory management unit
412 data processing cluster
414 primitive engine
416 M-pipe controller
500 memory partition unit
502 raster operations unit
504 level two cache
506 memory interface
600 streaming multiprocessor
602 instruction cache
604 scheduler unit
606 register file
608 core
610 special function unit
612 load/store unit
614 interconnect network
616 shared memory/L1 cache
618 dispatch
700 processing system
702 central processing unit
704 switch
706 parallel processing module
800 exemplary processing system
802 communications bus
804 main memory
806 input devices
808 display devices
810 network interface
900 data center
902 data center infrastructure layer
904 resource orchestrator
906 grouped computing resources
908a node computing resource
908b node computing resource
908c node computing resource
910 framework layer
912 job scheduler
914 configuration manager
916 distributed file system
918 resource manager
920 software layer
922 software
924 application layer
926 application(s)

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A process for configuring a text-to-volumetric video transformer, the process comprising:
transforming a text prompt into a three-dimensional (3D) neural radiance field; and
applying a four-dimensional multi-resolution deformation field to generate time-varying displacements for the three-dimensional neural radiance field consistent with motion expressed in the text prompt, while maintaining a content of the three-dimensional neural radiance field static.

2. The process of claim 1, wherein the four-dimensional multi-resolution deformation field comprises a four-dimensional to three-dimensional time-dependent mapping D (x_{d}, t)→x_{c}, where x_{d} is a 3D point's location in deformed space at time t, and x_{c} is the point's corresponding location in the three-dimensional neural radiance field.

3. The process of claim 1, wherein the three-dimensional neural radiance field comprises multi-resolution feature grids.

4. The process of claim 1, wherein the four-dimensional multi-resolution deformation field comprises multi-resolution feature grids.

5. The process of claim 1, wherein the three-dimensional neural radiance field comprises a feature grid resolution at least five times greater than a feature grid resolution of the four-dimensional multi-resolution deformation field.

6. The process of claim 1, wherein the four-dimensional multi-resolution deformation field is formed via score distillation from a video diffusion model.

7. The process of claim 6, wherein the score distillation comprises a score distillation sampling (SDS) loss.

8. The process of claim 1, wherein a total variation loss is applied to the generated displacements.

9. A text-to-volumetric video transformer comprising:
a first stage configured to transform a text prompt into a three-dimensional (3D) neural radiance field; and
a second stage configured to apply a four-dimensional multi-resolution deformation field to generate time-varying displacements for the three-dimensional neural radiance field consistent with motion expressed in the text prompt, while maintaining a content of the three-dimensional neural radiance field static.

10. The text-to-volumetric video transformer of claim 9, wherein the four-dimensional multi-resolution deformation field comprises a four-dimensional to three-dimensional time-dependent mapping D (x_{d}, t)→x_{c}, where x_{d} is a 3D point's location in deformed space at time t, and x_{c} is the point's corresponding location in the three-dimensional neural radiance field.

11. The text-to-volumetric video transformer of claim 9, wherein the three-dimensional neural radiance field comprises multi-resolution feature grids.

12. The text-to-volumetric video transformer of claim 9, wherein the four-dimensional multi-resolution deformation field comprises multi-resolution feature grids.

13. The text-to-volumetric video transformer of claim 9, wherein the three-dimensional neural radiance field comprises a feature grid resolution at least five times greater than a feature grid resolution of the four-dimensional multi-resolution deformation field.

14. The text-to-volumetric video transformer of claim 9, wherein the four-dimensional multi-resolution deformation field is formed via score distillation from a video diffusion model.

15. The text-to-volumetric video transformer of claim 14, where the score distillation comprises an SDS loss.

16. The text-to-volumetric video transformer of claim 9, configured to apply a total variation loss to the generated displacements.

17. A text-to-volumetric video transformer comprising:
a three-dimensional (3D) diffusion model configured to transform a text prompt into a three-dimensional neural radiance field; and
a video generating model configured to apply a four-dimensional multi-resolution deformation field to generate time-varying displacements of the three-dimensional neural radiance field consistent with motion expressed in the text prompt, while maintaining a content of the three-dimensional neural radiance field static.

18. The text-to-volumetric video transformer of claim 17, wherein the three-dimensional diffusion model is configured to receive diffusion guidance from one or both of a pre-trained 3D diffusion model and a pre-trained two-dimensional (2D) diffusion model.

19. The text-to-volumetric video transformer of claim 17, wherein the video generating model is configured to receive diffusion guidance from a pre-trained video diffusion model.

20. The text-to-volumetric video transformer of claim 17, wherein the four-dimensional multi-resolution deformation field comprises a four-dimensional to three-dimensional time-dependent mapping D (x_{d}, t)→x_{c}, where x_{d} is a 3D point's location in deformed space at time t, and x_{c} is the point's corresponding location in the three-dimensional neural radiance field.
